(19) United States
(12) Patent Application Publication
(10) Pub. No.: US 2011/0099556 A1
(43) Pub. Date: Apr. 28, 2011

(54) UPDATING SYSTEM FOR A MICROCONTROLLER AND ASSOCIATED METHODS

(75) Inventors: Thomas C. Long, Poughkeepsie, NY (US); Robert P. Makowicki, Staatsburg, NY (US)

(73) Assignee: International Business Machines Corporation, Armonk, NY (US)

(21) Appl. No.: 12/603,601

(22) Filed: Oct. 22, 2009

(51) Int. Cl. G06F 9/44

(52) U.S. Cl. 719/312

(57) ABSTRACT

A system to update portions of a microcontroller may include a microcontroller and read-write memory carried by the microcontroller. The system may also include non-volatile memory carried by the microcontroller and an application carried by the non-volatile memory. The system may further include a second application carried by the non-volatile memory that substantially mirrors the application.

### BACKGROUND OF THE INVENTION

1. Field of the Invention

The invention relates to the field of computer systems, and, more particularly, to updating portions of a microcontroller.

2. Description of Background

Generally, the contents of nonvolatile memory are not lost when power is cycled to the microcontroller. However, the contents of the nonvolatile memory may be updateable using a microcontroller's built-in flash reprogramming capability. In contrast, the contents of volatile memory may be lost when power is cycled to the microcontroller.

Firmware may be the code that runs in the nonvolatile memory and volatile memory of the microcontroller. Power-On-Reset may be when a microcontroller is powered on from a cold start and code execution may begin at a nonvolatile memory location that is fixed in hardware by the microcontroller. All necessary hardware and software initializations may be performed in the Power-On-Reset function.

In a flash update, all or part of the microcontroller's nonvolatile memory may be rewritten with new code. The flash update algorithm may be executed from volatile memory because it is not possible to update any part of the nonvolatile memory while executing code from the nonvolatile memory.

A boot sector may be a semi-permanent area at the beginning of nonvolatile memory that provides a minimal function set such as Power-On-Reset and the minimum code necessary to enable a component to function. The purpose of having a boot sector may be to provide the necessary hardware initializations for the microcontroller.

An application sector may be an area of the nonvolatile memory that contains the code required to run the application including essential function such as cyclic monitor, error detection, fault isolation, and the like. Application code updates are common, and are normally performed to add new function or fixes.

### SUMMARY OF THE INVENTION

According to one embodiment of the invention, a system to update portions of a microcontroller may include a microcontroller and read-write memory carried by the microcontroller. The system may also include non-volatile memory carried by the microcontroller and an application carried by the non-volatile memory. The system may further include a second application carried by the non-volatile memory that substantially mirrors the application.

The application and the second application may comprise functionally equivalent firmware. The read-write memory may comprise shared space between the application and the second application, and state data in the shared space may be persistent through jumps between the application and the second application.

The application may be reprogrammed while the second application provides its functionality to the microcontroller, and the second application may be reprogrammed while the application provides its functionality to the microcontroller. The read-write memory may comprise a dynamically loadable program to perform flash-erase and/or flash-program when reprogramming the application and/or the second application.

The microcontroller may not require redundant non-volatile memory. The non-volatile memory may comprise an updateable boot application and/or read-only memory. The boot application may perform only verifying data in the application and/or the second application, and/or transferring execution to either one with verified data.

The boot application may contain no communications code and/or recovery routine. The microcontroller may perform command functions and/or control functions on a power/thermal component.

Another aspect of the invention is a method to update portions of a microcontroller. The method may include carrying read-write memory and non-volatile memory with a microcontroller. The method may also include substantially mirroring an application carried by the non-volatile memory by a second application carried by the non-volatile memory.

The method may further include sharing space between the application and the second application in the read-write memory and permitting state data in the shared space to be accessed by both the application and the second application. The method may additionally include reprogramming the application while the second application provides equivalent functionality to the microcontroller, and reprogramming the second application while the application provides equivalent functionality to the microcontroller.

The method may also include performing flash-erase and/or flash-program when reprogramming the application and/or the second application with a dynamically loadable program carried by the read-write memory. The method may further include performing, via boot application, only verifying data in the application and/or the second application, and/or transferring execution to the one with verified data.

Another aspect of the invention is a computer program product to update portions of a microcontroller. The computer readable program code may be configured to carry read-write memory and non-volatile memory with a microcontroller. The computer readable program code may also substantially mirror an application carried by the non-volatile memory by a second application carried by the non-volatile memory.

The computer readable program code may be configured to further share space between the application and the second application in the read-write memory, and permit state data in the shared space to be accessed by both the application and the second application.

The computer readable program codes may be configured to also reprogram the application while the second application provides equivalent functionality to the microcontroller, and reprogram the second application while the application provides equivalent functionality to the microcontroller. The computer readable program codes may be further configured to perform flash-erase and/or flash-program when reprogramming the application and/or the second application with a dynamically loadable program carried by the read-write memory.

The computer readable program codes may additionally be configured to perform, via boot application, verifying data in the application and/or the second application, and transfer execution to the one with verified data.

The system may comprise a microcontroller, read-write memory carried by the microcontroller, and non-volatile memory carried by the microcontroller. The system may also include a boot application carried by the non-volatile memory and an application carried by the non-volatile memory. The system may further include a second application carried by the non-volatile memory that substantially functionally mirrors the application.

The system may additionally include the boot application, the application, and/or the second application as updateable by a code driver carried by the read-write memory. The system may also include the reprogramming initiating with a single command that targets the application or the second application not providing its functionality to the microcontroller at that time.

### BRIEF DESCRIPTION OF THE DRAWINGS

FIG. 1 is a schematic block diagram of a system to update portions of a microcontroller in accordance with the invention.

FIG. 2 is a flowchart illustrating method aspects according to the invention.

FIG. 3 is a flowchart illustrating method aspects according to the method of FIG. 2.

FIG. 4 is a flowchart illustrating method aspects according to the method of FIG. 2.

FIG. 5 is a flowchart illustrating method aspects according to the method of FIG. 2.

FIG. 6 is a flowchart illustrating method aspects according to the method of FIG. 2.

FIG. 7 is a flow diagram of an update algorithm in accordance with the invention.

FIG. 8 is a flowchart illustrating boot application method aspects according to the invention.

### DETAILED DESCRIPTION OF THE INVENTION

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

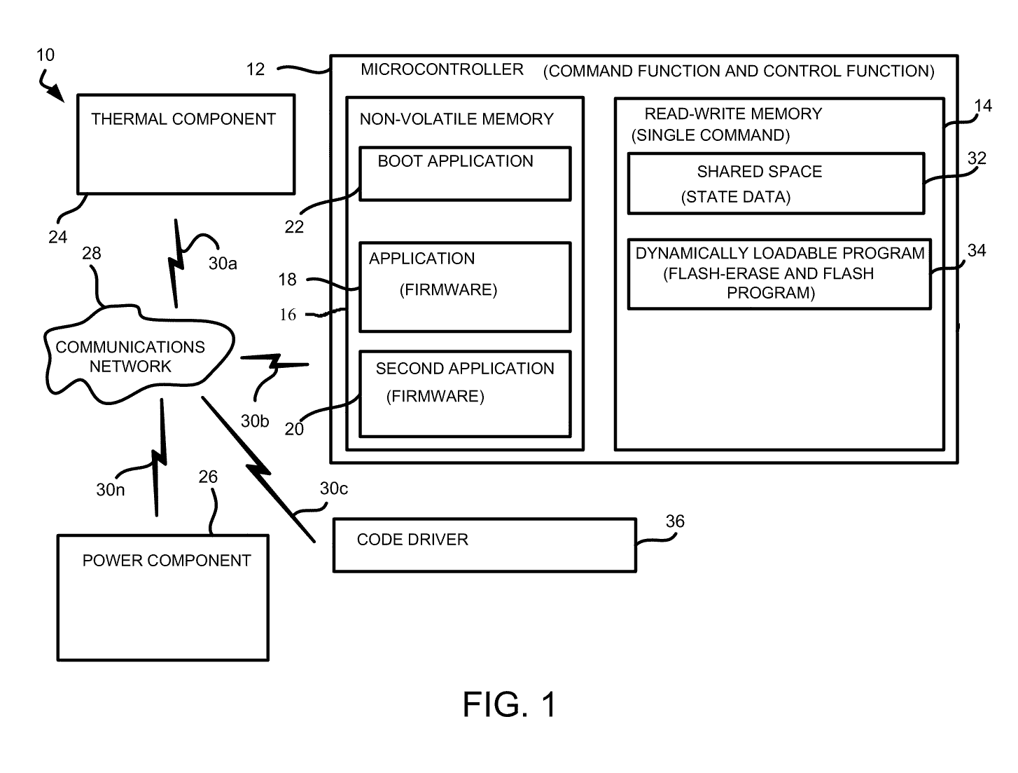

With reference now to FIG. 1, a system 10 to update portions of a microcontroller is initially described. The system 10 is a programmable apparatus that stores and manipulates data according to an instruction set as will be appreciated by those of skill in the art.

According to one embodiment of the invention, the system 10 includes a microcontroller 12 and read-write memory 14 carried by the microcontroller. In another embodiment, the system 10 includes non-volatile memory 16 carried by the microcontroller 12 and an application 18 carried by the non-volatile memory. In one embodiment, the system 10 includes a second application 20 carried by the non-volatile memory 16 that substantially mirrors the application 18.

In one embodiment, the application 18 and the second application 20 comprise functionally equivalent firmware. In another embodiment, the read-write memory 14 comprises shared space 32 between the application 18 and the second application 20, and state data in the shared space is persistent through jumps between the application and the second application.

In one embodiment, the application 18 is reprogrammed while the second application 20 provides its functionality to the microcontroller 12, and the second application is reprogrammed while the application provides its functionality to the microcontroller. In another embodiment, the read-write memory 14 comprises a dynamically loadable program 34 to perform flash-erase and/or flash-program when reprogramming the application 18 and/or the second application 20.

In one embodiment, the microcontroller 12 does not require redundant non-volatile memory 16. In another embodiment, the non-volatile memory 16 comprises an updateable boot application 22 and/or read-only memory. In another embodiment, the boot application 22 performs only verifying data in the application 18 and/or the second application 20, and/or transferring execution to either one with verified data.

In one embodiment, the boot application 22 contains no communications code and/or recovery routine. In another embodiment, the microcontroller 12 performs command functions and/or control functions on at least one power component 26 and/or a thermal component 24.

In one embodiment, the system 10 includes a communications network 28, which enables a signal to travel anywhere within system 10 and/or to any other system connected to system 10. The communications network 28 is wired and/or wireless, for example. The communications network 28 is local and/or global with respect to system 10, for instance. The communications network 28 includes communications links 30a-30n as will be appreciated by those of skill in the art.

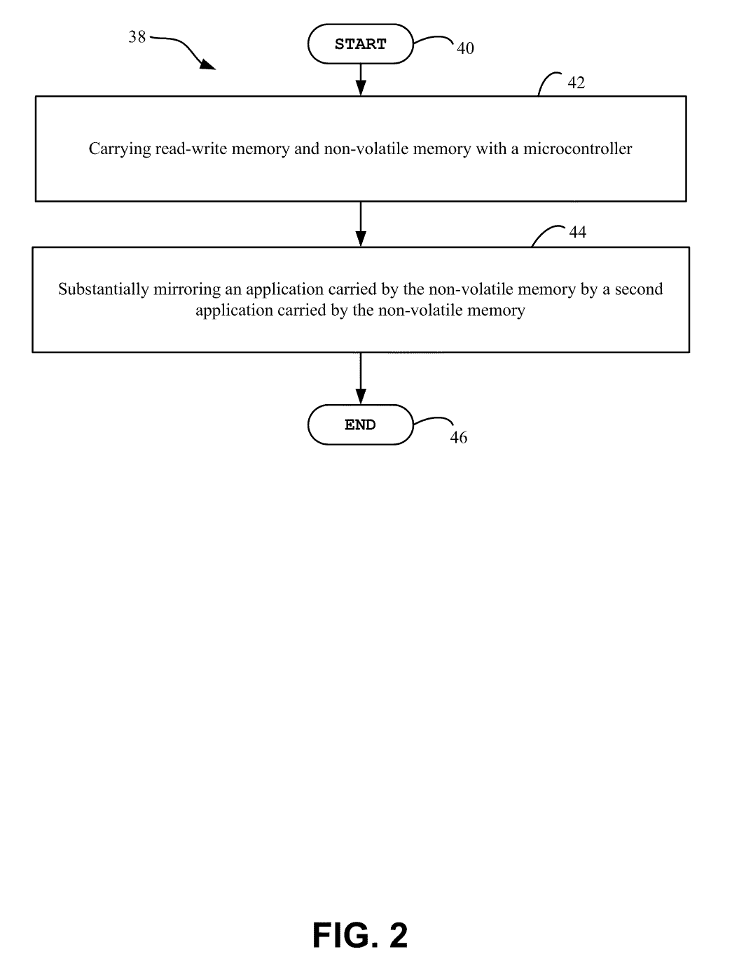

Another aspect of the invention is a method to update portions of a microcontroller, which is now described with reference to flowchart 38 of FIG. 2. The method begins at Block 40 and may include carrying read-write memory and non-volatile memory with a microcontroller at Block 42. The method may also include substantially mirroring an application carried by the non-volatile memory by a second application carried by the non-volatile memory at Block 44. The method ends at Block 46.

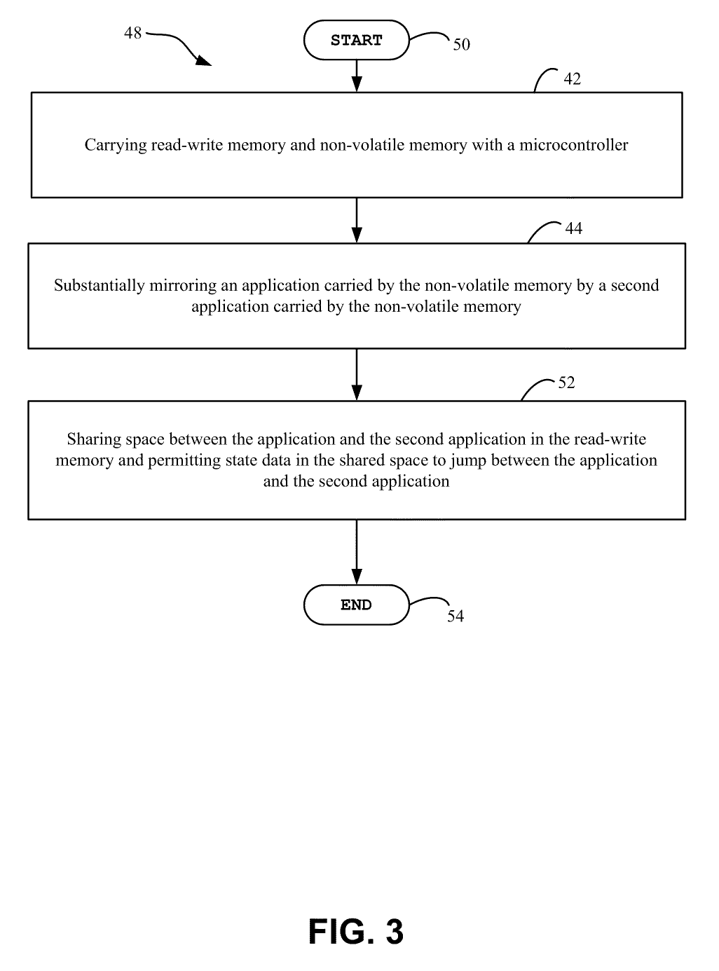

In another method embodiment, which is now described with reference to flowchart 48 of FIG. 3, the method begins at Block 50. The method may include the steps of FIG. 2 at Blocks 42 and 44. The method may additionally include sharing space between the application and the second application in the read-write memory and permitting state data in the shared space to be accessed by both the application and the second application at Block 52. The method ends at Block 54.

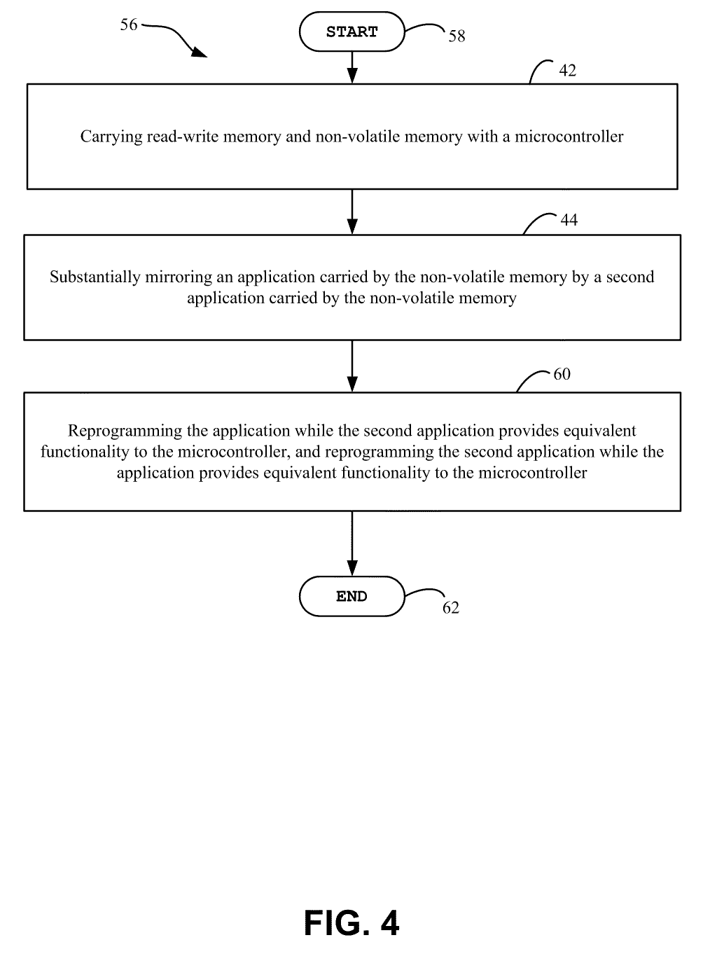

In another method embodiment, which is now described with reference to flowchart 56 of FIG. 4, the method begins at Block 58. The method may include the steps of FIG. 2 at Blocks 42 and 44. The method may additionally include reprogramming the application while the second application provides equivalent functionality to the microcontroller, and reprogramming the second application while the application provides equivalent functionality to the microcontroller at Block 60. The method ends at Block 62.

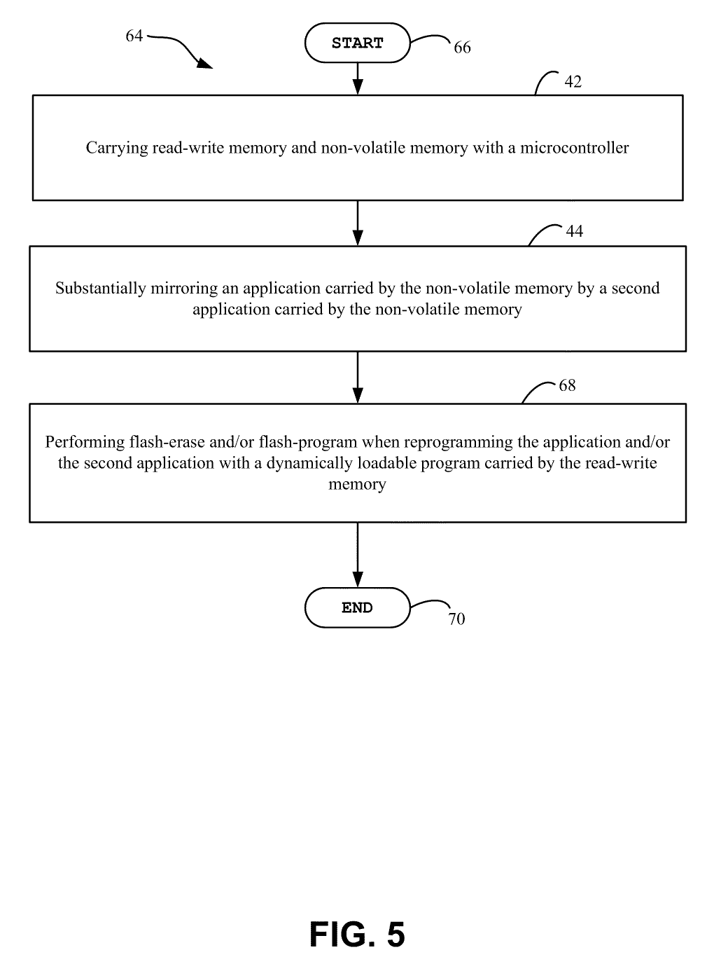

In another method embodiment, which is now described with reference to flowchart 64 of FIG. 5, the method begins at Block 66. The method may include the steps of FIG. 2 at Blocks 42 and 44. The method may additionally include performing flash-erase and/or flash-program when reprogramming the application and/or the second application with a dynamically loadable program carried by the read-write memory at Block 68. The method ends at Block 70.

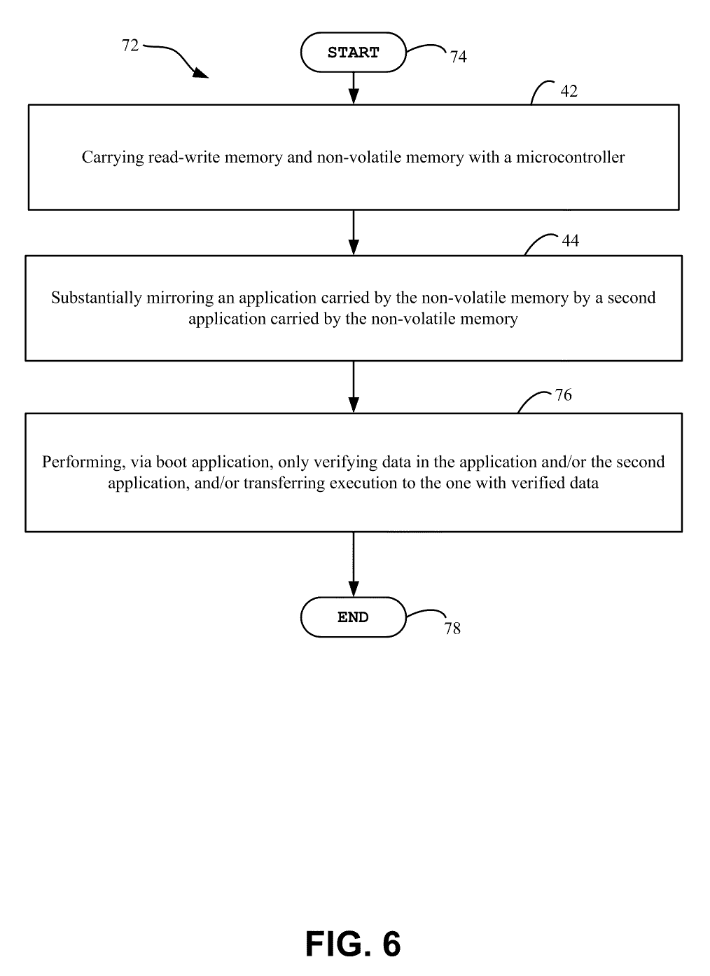

In another method embodiment, which is now described with reference to flowchart 72 of FIG. 6, the method begins at Block 74. The method may include the steps of FIG. 2 at Blocks 42 and 44. The method may additionally include performing, via boot application, only verifying data in the application and/or the second application, and/or transferring execution to the one with verified data at Block 76. The method ends at Block 78.

Another aspect of the invention is a computer readable program codes coupled to tangible media to update portions of a microcontroller 12. In one embodiment, the computer readable program codes are configured to carry read-write memory 14 and non-volatile memory 16 with a microcontroller 12. In another embodiment, the computer readable program codes substantially mirror an application 18 carried by the non-volatile memory 16 by a second application 20 carried by the non-volatile memory.

In one embodiment, the computer readable program codes provide shared space 32 between the application 18 and the second application 20 in the read-write memory 14, and permit state data in the shared space to be accessed by both the application and the second application. In another embodiment, the computer readable program codes reprogram the application 18 while the second application 20 provides equivalent functionality to the microcontroller 12, and reprogram the second application while the application provides equivalent functionality to the microcontroller.

In one embodiment, the computer readable program codes perform flash-erase and/or flash-program when reprogramming the application 18 and/or the second application 20 with a dynamically loadable program 34 carried by the read-write memory 14. In another embodiment, the computer readable program codes perform, via boot application 22, verification of data in the application 18 and/or the second application 20, and transfers execution to the one with verified data.

In one embodiment, the system 10 comprises a microcontroller 12, read-write memory 14 carried by the microcontroller, and non-volatile memory 16 carried by the microcontroller. In another embodiment, the system 10 includes a boot application 22 carried by the non-volatile memory 16 and an application 18 carried by the non-volatile memory. In one embodiment, the system 10 includes a second application 20 carried by the non-volatile memory 16 that substantially functionally mirrors the application 18.

In another embodiment, the system 10 includes the boot application 22, the application 18, and/or the second application 20 as updateable by a code driver 36 carried by the read-write memory 14. In one embodiment, the code driver 36 is transmitted over the communications network 28 and carries the dynamically loadable program 34. In another embodiment, the system 10 includes the reprogramming initiating with a single command that targets the application 18 or the second application 20 not providing its functionality to the microcontroller 12 at that time.

In view of the foregoing, the system 10 addresses updating portions of a microcontroller 12, for example. For instance, the system 10 performs concurrent flash non-volatile memory 16, e.g. read only memory (“ROM”) firmware updates on embedded microcontrollers 12 performing Power/Thermal control function in a high-availability, fault-tolerant, high-performance server.

In one embodiment, the system 10 has a firmware design that uses two ROM “application” sectors, rather than one. In another embodiment, the system 10 has a firmware design that uses a ROM boot application 22, e.g. “boot” sector, with minimal function, to minimize the probability that the boot application 22 will require updating. In one embodiment, the system 10 has a firmware design that uses dynamically loadable computer programs 34, resident in read-write memory 14, e.g. Random-Access-Memory (“RAM”), which performs flash-erase and flash-program function.

Currently, in order to perform a ROM flash update, the functions performing the update must be running from RAM. The microcontroller does not permit the ROM to be erased or programmed, unless the update functions are executed from RAM.

Because of such, the firmware application is stopped while a flash update is in progress. This, in turn, means that essential processes, e.g. cyclic function monitor, error detection, fault isolation, are not running during flash update. This creates an undesirable situation, as the health of the field replaceable unit (“FRU”) cannot be determined during this time.

The further implication at system level is that in order to perform flash update on a Power/Thermal component, the target component must be “redundant”, from a system perspective. Redundancy in this context means that turning off the target component does not affect the overall system function. In practical terms, that requires the presence of at least two components, which allows one to be turned off, with the load taken up by the remaining component(s).

A benefit to removing the constraints of component redundancy is that the updates can take place in parallel rather than in sequence. In the present design, to update two Power/Thermal components, the first is turned off and updated while the second continues to run its application, and then the first is turned back on and the second is turned off and updated. Without the constraints of the redundancy requirement, both components could be updated at the same time, reducing the overall system flash update time.

In situations where a failure occurs during flash update of the application, the boot sector performs its “safety net” function by allowing the component to reboot and communicate. However, if the flash update failure is fatal, rather than transient, e.g. due to a hardware failure preventing the ROM from being burned, the “boot code only” state will persist for an extended period of time, meaning the application code's essential functions (cyclic monitor, error detection, fault isolation) are not running during that time.

During those times that a boot sector update is performed, there is a window of vulnerability during which it is possible to lose communication with the microcontroller, meaning that an in-system flash update is no longer possible. This window is the time after the boot sector is erased, and before it is completely rewritten. If the microcontroller loses power during that time window, the boot sector will be in a partially-programmed state, leaving it unable to reboot. When this occurs, communication is lost, and in-system flash update is no longer possible. In this situation, a service call must be made to replace the FRU.

In one embodiment, the system 10 solves the problems described above by dividing the ROM application space into two parts, e.g. first and second or high and low, each with its own substantially identical copy of the application code. When a cold start occurs, the boot code is executed. The boot code checks the integrity of each application sector, and transfers execution to the one with the valid cyclic redundancy check (“CRC”). If both are valid, execution is transferred to the application 18 or low. By design, there is always least one valid application sector present.

In another embodiment, the boot application 22 does not need to perform communications, it has substantially less function, less complexity, and smaller code space than in previous designs. This reduced function means that the probability of requiring a boot sector code update is minimal (approaching zero). This substantially reduces the probability of a failure during the boot update “window of vulnerability”.

In one embodiment, application sector flash updates are performed completely concurrently, that is, the application code never stops running during the update. This is possible due to the dual-image approach. While running the application in “this” sector, the “other” sector is updated. In another embodiment, due to the inherent hardware limitation of the flash process, the erase and program operations are executed from RAM. This is accomplished by calling “erase” and “program” functions resident in RAM, from the application code. In one embodiment, execution is transferred momentarily to RAM to perform one of these operations, and is returned to the application as soon as the operation is complete. To the outside world, this is transparent, and it appears that the application was never interrupted.

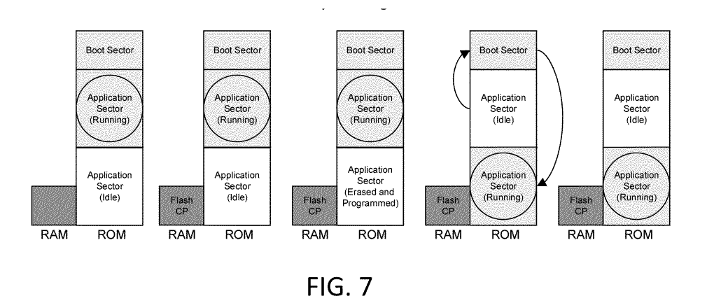

With addition reference to FIG. 7, in one embodiment, a flash update flow diagram is described. Cell one, from left to right in the figure, illustrates the application running. Cell two illustrates the code writing the flash functions to RAM by stopping the application, writing the flash control program to RAM, and transferring execution to the flash control program.

Cell three illustrates “This” image calls the flash functions to erase and program the ‘other’ image and the flash control program erases the application sector. Cell four illustrates that “This” image verifies the integrity of the “other” image and transfers execution in real time and the flash control program reprograms the application sector. And cell five illustrates that cell 2 can be repeated to update the new “other” image and the flash control program transfers execution to the boot sector, which restarts the application.

In one embodiment, the component's application continues to run during flash update, meaning essential application functions are never suspended. In another embodiment, application flash updates can proceed without the requirement of component redundancy, meaning updates are possible even in N-mode systems.

In one embodiment, application flash updates can proceed in parallel rather than in series, reducing the overall flash update time. In another embodiment, “Boot code only” situations are avoided, due to the presence of at least one application sector at all times.

In one embodiment, the possibility of FRU failure during the boot sector's “window of vulnerability” is reduced substantially, approaching zero, due to the low probability that the boot sector will require a flash update.

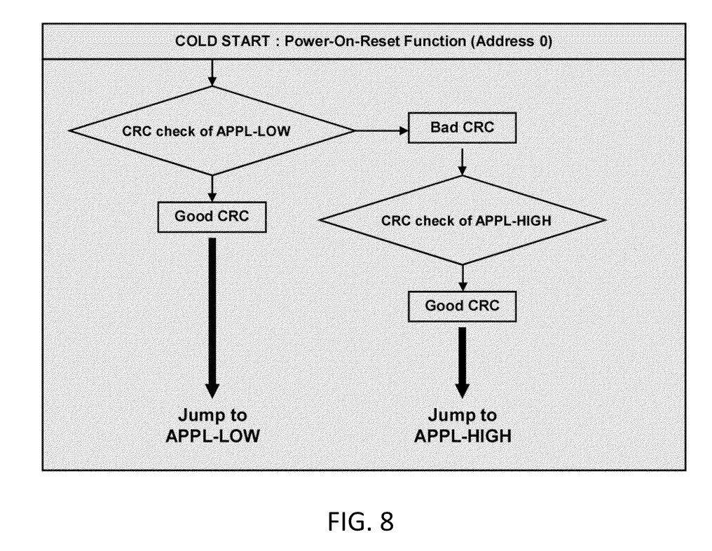

With additional reference to FIG. 8, in one embodiment, when power is applied to the microcontroller 12 (a “cold start”), the microcontroller executes the code pointed to by ROM 16 address 0 (the Power-On-Reset vector). This address is in the boot sector 22 of the dual-image microcontroller 12.

In another embodiment, when the boot code executes the Power-On-Reset function, the following steps are performed: 1) Initialize the microcontroller hardware (ROM, RAM, digital I/O, etc); 2) Perform a CRC check on the LOW application area. If CRC-good, the boot code transfers execution to the LOW application; and 3) If the LOW application's CRC is invalid, the boot code calculates the CRC of the HIGH application area.

In one embodiment, by design, there is at least one valid application area, so the boot code transfers execution to HIGH. In another embodiment, the flash update process is initiated by Power/Thermal code, when the code determines that there is a version mismatch between the current code running on a FRU's microcontroller 12, and target code version in the most recent code driver.

In one embodiment, since redundancy checks are not required for FRUs which have the dual image design, the code can initiate flash updates to these FRUs in parallel (one thread per FRU). In another embodiment, the application is running out of ‘this’ image, and the ‘other’ image is being updated. Note that either the HIGH or LOW application image can be ‘this’ or ‘other’.

In one embodiment, the code writes the flash-erase and flash-program functions to the reserved area in RAM. The flash-erase and flash-program functions are incorporated as part of the code driver. In another embodiment, the code sends the command to ‘this’ application to erase the ‘other’ image. ‘This’ application calls the erase function resident in RAM, and the ‘other’ image is erased. The erase function returns and ‘this’ continues to run its application.

In one embodiment, the code writes 8 KB of code to a specified area (“buffer”) in RAM. In another embodiment, the code sends the command to ‘this’ application to program the contents of the buffer to the appropriate address in the ‘other’ ROM space. ‘This’ application calls the program function resident in RAM, and the buffer contents is programmed to its ‘other’ ROM address. The program function returns, and ‘this’ continues to run its application.

In one embodiment, the code repeats the two proceeding actions until the entire ‘other’ ROM space is updated. In another embodiment, the code performs a CRC check on the ‘other’ image to verify the integrity of the code. (If the CRC check fails, the process can be tried again as many times as desired. ‘This’ image continues to run its application, so the FRU remains fully functional.)

In one embodiment, when the ‘other’ image code integrity is verified, the code sends the command to ‘this’ application to switch execution to the ‘other’ application. In another embodiment, the act of switching execution means that the image that was previously ‘other’ is now ‘this’, and the image that was previously ‘this’ is now ‘other’. In one embodiment, if ‘other’ is not up to date, the code repeats the process starting from the first action). In the entire flash update process, ‘this’ image has continued to run its application transparently to the outside world.

In one embodiment, the system 10 supports in-system boot sector 22 updates, as it is recognized that the boot sector algorithm may require changes, or fixes. In another embodiment, the boot sector 22 is updateable in the same way the application sectors 18 and 20 are updateable; that is, the updates can occur at any time, by execution of a RAM-based update program that is shipped along with the updated ROM code in a code driver 36, and executed by external command, e.g. by Power/Thermal code which communicates with the microcontroller 12. The ability to update the boot sector simply by shipping a new software driver is a significant competitive advantage, considering that the alternative is to perform a field replacement of the component.

In one embodiment, the system 10 specifies a more flexible boot algorithm. In its basic form it determines which application sector to execute, based first on having a good CRC calculation, and second on which application sector has the numerically higher code version. Additionally, in response to an external command, the firmware provides the ability to jump to a specific application sector 18 or 20. In another embodiment, the system 10 algorithm provides the ability to ignore any CRC error which may exist, and jump unconditionally to a specific application sector 18 or 20.

In one embodiment, the system 10 contains logic that allows the external driver (in our case, Power/Thermal code) to send a generalized “Erase” or “Program” command, which automatically targets the “other” application sector 18 or 20, preventing accidental erasure or programming of “this” application sector (“this” refers to the currently executing application sector, and “other” refers to the application sector which is not currently executing and can therefore be updated).

In one embodiment, the system 10 includes the specification of a common RAM 14 space, in which vital state data is persistent through jumps from one logical ROM 16 application sector 18 or 20 to the other. This allows a truly seamless transition between application sectors 18 or 20, since the state data does not have to be refreshed following the jump.

In one embodiment, this is accomplished by first pinning the key variables at specific memory locations (a basic prerequisite), but in addition, system 10 provides for an application code “warm start” after the half-image update, which preserves the state information which is written to those key variables. In contrast, the normal procedure for a microcontroller is to perform a “cold start” in which all RAM variables are initialized to zero, requiring the state data to be refreshed.

In one embodiment, the system 10 uses a single microcontroller 12 device; a single chip encompassing CPU, ROM, RAM, and I/O capability. In another embodiment, the system 10 enables the single ROM 16 space in the microcontroller 12 to be logically divided, so it effectively becomes two separately addressable ROM devices.

In one embodiment, the system 10 includes the sharing of a common RAM 14 space, in which vital state data is persistent through jumps from one logical ROM 16 application sector 18 or 20 to the other. In another embodiment, the system 10 has no constraints on when the update may occur. The update can be performed at any time, and is transparent to the overall computer system, by design.

In one embodiment, the system 10, rather than writing the RAM 14 update program to a storage area in ROM 16, the external driver writes the RAM control program directly to RAM, thus saving ROM memory space.

In one embodiment, system 10 provides executable ROM 16 code (not simply configuration data), residing on a single microcontroller 12 device. In another embodiment, the system 10 “Dual ROM image” approach increases the intrinsic reliability of flash updates. In another embodiment, concurrent flash update allows flash updates while the application continues to run.

In one embodiment, system-level requirement of component “redundancy” is eliminated. In another embodiment, FRU downtime due to ‘partial code load” condition is virtually eliminated.

In one embodiment, the two application sectors 18 or 20 are built from the same source code, so they have identical function. In another embodiment, the boot sector 22 contains minimal code, and its only function is to check the application sectors 18 or 20 for a valid CRC and transfer execution there. In another embodiment, the boot sector 22 contains no communications code.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
a microcontroller;
read-write memory carried by said microcontroller;
non-volatile memory carried by said microcontroller;
an application carried by said non-volatile memory; and
a second application carried by said non-volatile memory that substantially mirrors said application.

2. The system of claim 1 wherein said application and said second application comprise functionally equivalent firmware.

3. The system of claim 2 wherein said read-write memory comprises shared space between said application and said second application, and state data in the shared space is persistent through jumps between said application and said second application.

4. The system of claim 2 wherein said application is reprogrammed while said second application provides its functionality to said microcontroller, and said second application is reprogrammed while said application provides its functionality to said microcontroller.

5. The system of claim 1 wherein said read-write memory comprises a dynamically loadable program to perform at least one of flash-erase and flash-program when reprogramming at least one of said application and said second application.

6. The system of claim 4 wherein said microcontroller does not require redundant non-volatile memory.

7. The system of claim 1 wherein said non-volatile memory comprises at least one of an updateable boot application and read-only memory.

8. The system of claim 7 wherein the boot application performs only at least one of verifying data in at least one of said application and said second application and transferring execution to either one with verified data.

9. The system of claim 7 wherein the boot application contains no communications code and recovery routine.

10. The system of claim 1 wherein said microcontroller performs at least one of command functions and control functions on a power/thermal component.

11. A method comprising:
carrying read-write memory and non-volatile memory with a microcontroller; and
substantially mirroring an application carried by the non-volatile memory by a second application carried by the non-volatile memory.

12. The method of claim 11 further comprising sharing space between the application and the second application in the read-write memory and permitting state data in the shared space to be shared between the application and the second application.

13. The method of claim 11 further comprising reprogramming the application while the second application provides equivalent functionality to the microcontroller, and reprogramming the second application while the application provides equivalent functionality to the microcontroller.

14. The method of claim 11 further comprising performing at least one of flash-erase and flash-program when reprogramming at least one of the application and the second application with a dynamically loadable program carried by the read-write memory.

15. The method of claim 11 performing, via boot application, only at least one of verifying data in at least one of the application and the second application and transferring execution to the one with verified data.

16. A computer program product to update portions of a microcontroller, the computer program product comprising:
a computer readable storage medium having computer readable program code embodied therewith, the computer readable program code comprising:
computer readable program code configured to provide read-write memory and non-volatile memory to a microcontroller; and
computer readable program code configured to substantially mirror an application carried by the non-volatile memory by a second application carried by the non-volatile memory.

17. The computer program product of claim 16 further comprising computer readable program code configured to share space between the application and the second application in the read-write memory and permit state data in the shared space to be accessed by both the application and the second application.

18. The computer program product of claim 16 further comprising computer readable program code configured to reprogram the application while the second application provides equivalent functionality to the microcontroller, and reprogram the second application while the application provides equivalent functionality to the microcontroller.

19. The computer program product of claim 16 further comprising computer readable program code configured to perform at least one of flash-erase and flash-program when reprogramming at least one of the application and the second application with a dynamically loadable program carried by the read-write memory.

20. The computer program product of claim 16 further comprising computer readable program code configured to perform, via boot application, only at least one of verifying data in at least one of the application and the second application and transfer execution to the one with verified data.

21. A system comprising:
a microcontroller;
read-write memory carried by said microcontroller;
non-volatile memory carried by said microcontroller;
a boot application carried by said non-volatile memory
an application carried by said non-volatile memory; and
a second application carried by said non-volatile memory that substantially functionally mirrors said application.

22. The system of claim 21 wherein at least one of said boot application, said application, and said second application are updateable by a code driver carried by said read-write memory.

23. The system of claim 21 wherein said application is reprogrammed while said second application provides its functionality to said microcontroller, and said second application is reprogrammed while said application provides its functionality to said microcontroller.

24. The system of claim 23 wherein the reprogramming initiates with a single command that targets said application or said second application not providing its functionality to said microcontroller at that time.

25. The system of claim 21 wherein the boot application performs only at least one of verifying data in at least one of said application and said second application and transferring execution to either one with verified data.
